(19) United States
(12) Patent Application Publication
(10) Pub. No.: US 2009/0278337 A1
(43) Pub. Date: Nov. 12, 2009

(54) AIR BAG COVER

(75) Inventors: Heather Springer, West Olive, MI (US); Jeffrey T. Stout, Grand Rapids, MI (US); Ronald A. Bozio, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company, Holland, MI (US)

(21) Appl. No.: 11/721,310

(22) PCT Filed: Dec. 13, 2005
(86) PCT No.: PCT/US05/44934

§ 371 Date: Jun. 8, 2007

Related U.S. Application Data
(60) Provisional application No. 60/635,864, filed on Dec. 14, 2004.

(51) Int. Cl. B60R 21/20

(52) U.S. Cl. 280/728.3

(57) ABSTRACT

A molded air bag cover (10) for placement within a vehicle to cover an air bag. The air bag cover (10) comprises a first portion (19) providing a substantial portion of the air bag cover (10) and a second portion (20) defining a tear seam (16, 18). The first portion (19) has a first wall thickness; the second portion (20) has a second wall thickness greater than the first wall thickness. The air bag cover (10) opens to allow the air bag to pass through the air bag cover by surface fracture upon application of force by the air bag as the air bag is inflated. The wall thickness of the second portion (20) is configured to inhibit undesired fracture of the air bag cover.

### CROSS-REFERENCE TO RELATED PATENT APPLICATIONS

The present PCT Application claims priority to U.S. Provisional Application No. 60/635,864 entitled AIR BAG COVER, filed on Dec. 14, 2004, the full disclosure of which is hereby incorporated herein by reference.

### BACKGROUND

The present invention relates to a cover for a vehicle air bag. More specifically, the present invention relates to an air bag cover and method of making the same, the air bag cover having one or more tear seams which separate upon application of force such as the inflation of an air bag, thereby allowing the air bag to deploy through the cover at the tear seams.

It is generally known to provide air bag modules for protecting vehicle occupants. Many known systems utilize plastic fabricated air bag covers having tear seams or scores disposed on a surface of the air bag cover. These known tear seams or scores typically have selected weakened areas of the air bag cover where the inflating air bag initially separates or breaks through the air bag cover and moves toward a vehicle occupant to perform its intended safety function. However, some known systems may have significant tooling and manufacturing costs. For example, many known seamless air bag covers are laser and/or knife scored. These types of known covers require additional manufacturing operations for each cover, which can add capital and processing cost to each product that is made. In addition, some known air bag covers may be aesthetically unpleasing due to seam lines that are visible on the occupant side of the air bag cover (i.e., the “A” side or surface). Further, some known air bag covers may rely on seams that do not include sufficient support to maintain a desired width along the length of the seam, which may lead to aesthetically unpleasing indentations that are visible on the occupant side of the air bag cover. Furthermore, some known air bag covers may be ineffective in inhibiting or resisting surface fracture not on the intended tear seam or tearing of the air bag cover beyond the tear seam.

Accordingly, it would be advantageous to provide an air bag cover having lower tooling and manufacturing costs. It would also be advantageous to provide an air bag having lower labor costs. It would further be advantageous to provide an air bag that has aesthetically pleasing characteristics (e.g., substantially non-visible seam lines on an occupant side of the air bag cover). It would further be advantageous to provide an air bag cover that provides a tear seam having sufficient support to maintain a desired width along the tear seam length (e.g., to resist deformation). It would further be advantageous to provide an air bag cover that prevents and/or inhibits undesired surface fracture or tearing of an area of the air bag cover beyond or outside the intended tear seams. It would be desirable to provide for an air bag cover having one or more of these or other advantageous features. To provide an inexpensive, reliable, and widely adaptable air bag cover that avoids the above-referenced and other problems would represent a significant advance in the art.

### SUMMARY

The present invention relates to a molded air bag cover for placement within a vehicle to cover an air bag. The air bag cover comprises a first portion providing a substantial portion of the air bag cover and a second portion defining a tear seam. The first portion has a first wall thickness; the second portion has a second wall thickness greater than the first wall thickness. The air bag cover opens to allow the air bag to pass through the air bag cover by surface fracture upon application of force by the air bag as the air bag is inflated. The wall thickness of the second portion is configured to inhibit undesired fracture of the air bag cover.

The present invention also relates to an air bag cover for placement within a vehicle to cover an air bag. The air bag cover comprises a first portion and a second portion. The first portion comprises an outer surface that is configured to face an interior area of a vehicle for occupants and an inner surface opposite the outer surface. The second portion is provided on the first portion and has a greater wall thickness than the first portion to limit separation of the first portion beyond the tear seam. The inner surface of the air bag cover comprises a tear seam having a groove or recess that is defined by a pair of opposing surfaces on the inner surface of the second portion. The tear seam comprises a plurality of spaced apart members or bridges that extend across the width of the tear seam between the opposing surfaces of the groove. The air bag cover opens by surface fracture upon application of force by the air bag as the air bag is inflated.

The present invention further relates to a process for forming an air bag cover comprising introducing the polymeric material into a mold between a mold cavity and a core, forming a first portion comprising a first wall thickness, an outer surface configured to face an interior area of a vehicle for occupants, and an inner surface opposite the outer surface, forming a second fracture limiting portion provided on the first portion and having a second wall thickness greater than the first wall thickness, the second fracture limiting portion defining a tear seam, and demolding the injection material. The polymeric materials may comprise reaction injection molding (RIM) materials such that the air bag cover is formed by a reaction between the reaction injection molding materials.

The present invention further relates to a molded air bag cover for use in a vehicle to cover an air bag. The air bag cover comprises a first portion having an inner surface and an outer surface opposite the inner surface, the inner surface having a tear seam defined by a groove having a length and a width; and a plurality of members extending across the width of the groove to provide structural support to the first portion and inhibit deformation of the first portion along the tear seam. The air bag cover opens by surface fracture along the groove upon application of force by the air bag as the air bag is inflated to allow the air bag to pass through the air bag cover.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the disclosed embodiments.

### BRIEF DESCRIPTION OF THE DRAWINGS

FIG. 1 is a plan view of the occupant side of an air bag cover according to an exemplary embodiment. FIG. 2 is a plan view of the non-occupant side of an air bag cover according to a exemplary embodiment.

FIG. 3 is a cross-sectional view of an air bag cover taken along line 3-3 of FIG. 2 according to an exemplary embodiment.

FIG. 4 is a cross-sectional view of an air bag cover taken along line 4-4 of FIG. 2 according to an exemplary embodiment.

FIG. 5 is schematic representation of an apparatus for manufacturing an air bag cover using reaction injection molding according to an exemplary embodiment.

FIGS. 6A through 6D illustrate various process steps for manufacturing an air bag cover using reaction injection molding according to an exemplary embodiment.

FIG. 7 is a perspective view of the profile of a core used with a mold to form an air bag covet according to an exemplary embodiment.

### DETAILED DESCRIPTION OF THE PREFERRED AND EXEMPLARY EMBODIMENTS

Before beginning the detailed description of the preferred, exemplary and alternative embodiments of the present invention, several general comments can be made about the applicability and scope of this invention. It is to be understood that the invention is not limited to the details or methodology set forth in the following description or illustrated in the drawings. The invention is capable of other embodiments or being practiced or carried out in various ways. It is also to be understood that the phraseology and terminology employed herein is for the purpose of description and should not be regarded as limiting.

It should be appreciated that the present air bag cover described herein may be provided for use with a steering wheel. In addition, the air bag cover may be utilized in. any number of other locations within a vehicle to offer protection to any occupant including, but not limited to, a passenger side instrument panel, in the seats, door frames, roof line, etc. Further, although one particular general shape (e.g., an expanded or modified “H” configuration) for the tear seams is shown in the FIGURES, any number of tear seams and/or shapes can be utilized. For example, the overall tear seam shape may be an “H,” an “X,” a “U,” etc., or any other suitable configuration such that the tear seam separates upon application of force by the air bag thereby providing a location for passage through the air bag cover.

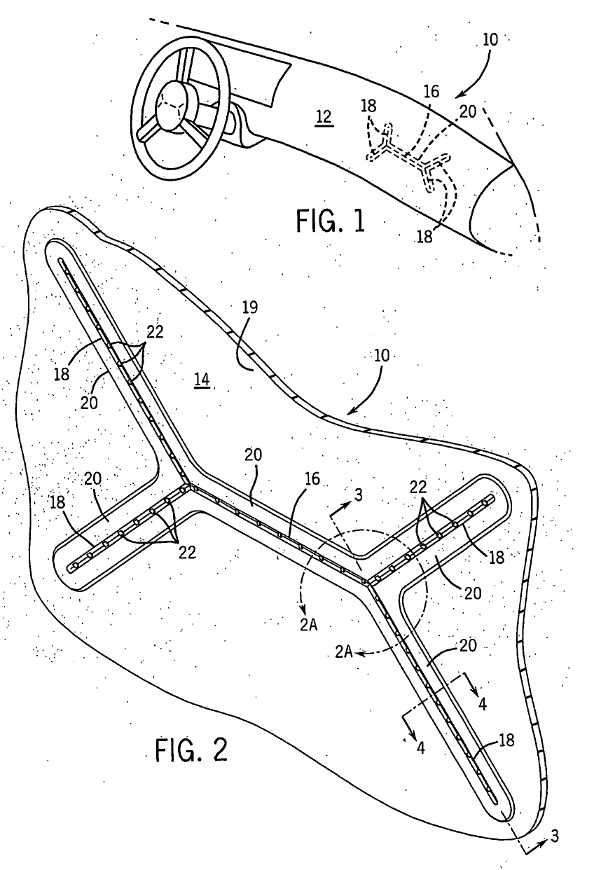

Referring to FIG. 1, an air bag cover 10 is shown. Cover 10 includes a first side (e.g., surface) or occupant side 12 (e.g., A-side, A-surface, outer, exterior, etc.) and a second side (e.g., surface) or non-occupant side 14 (e.g., B-side, B-surface, inner, interior, etc.). As shown in FIG. 2, non-occupant side 14 includes a primary tear seam 16 and one or more secondary tear seams 18 that intersect primary tear seam 16.

Cover 10 further comprises a first portion 19 and a second portion 20 (e.g., border, section, region, area, reinforcement member, etc.) that surrounds tear seams 16, 18. First portion 19 provides a substantial portion of the air bag cover. Second portion 20 is at least partially elevated or raised above the surface of first portion 19 of air bag cover 10 and tear seams 16, 18. Second portion 20 has a greater thickness than first portion 19 of cover 10. Generally, air bag cover 10 opens to allow the air bag to pass through air bag cover 10 by surface fracture upon application of a force along the tear seams by the air bag as the air bag is inflated. The greater wall thickness of second portion 20 relative to the rest of air bag cover 10 (e.g., first portion 19) is configured to inhibit undesired surface fracture or tearing at points along the surface or on areas of air bag cover 10 outside tear seams 16, 18. The increased wall thickness of second portion 20 is intended to provide sufficient resistance against the tearing action or separation of air bag cover 10 beyond tear seams 16, 18, thereby limiting any tearing to first portion 19 (outside of the tear seams) or second portion 20. As such, border section 20 provides strain and/or tension relief for air bag cover 10 and is intended to provide a barrier or reinforcement to prevent or inhibit undesired separation or splitting of cover 10 at a location or portion (e.g., area, point, etc.) of cover 10 other than at tear seams 16, 18 (e.g., separation of first portion or second portion beyond the tear seam). According to an alternative embodiment as shown in FIG. 9, the air bag cover is molded without second portion 20 (i.e., having first portion and tear seams 16, 18). According to various exemplary embodiments, the length of the tear seams and their relative angles may vary according to any number of configurations.

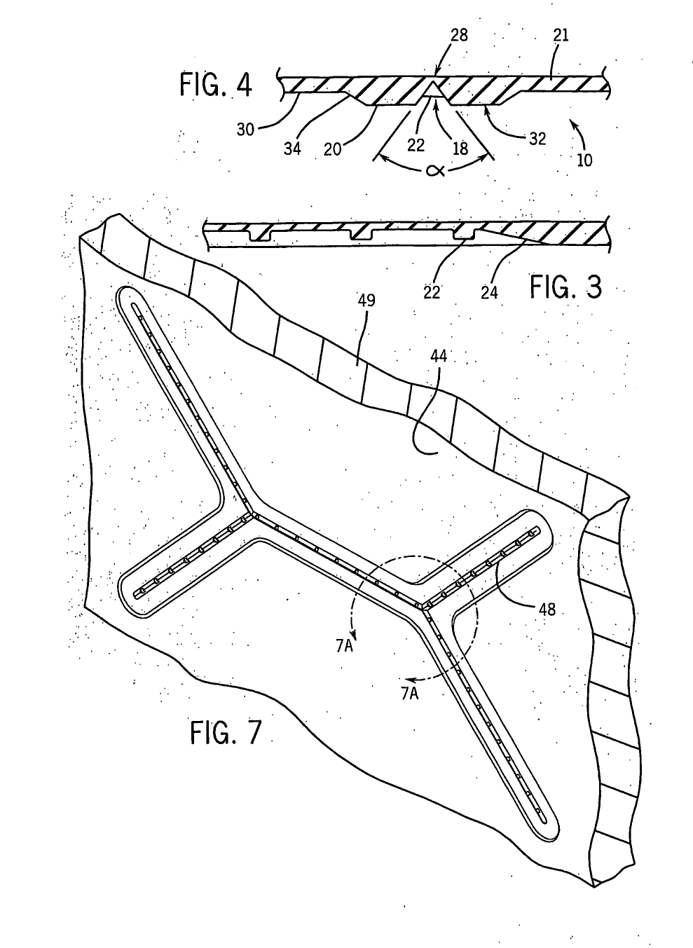

According to an exemplary embodiment, the wall thickness of cover 10 between surface 28 and surface 30 is in the range of about 0.5 to 1.5 mm, preferably in the range of about 0.75 to 1.25 mm. As shown in FIG. 4, cover 10 comprises border section 20 which extends (is raised) above surface 30 of cover 10. According to an exemplary embodiment, the wall thickness of border section 20 is in the range of about 1.5 to 2.5 mm between surface 28 and surface 32. According to A preferred embodiment, the wall thickness of border section 20 is in the range of about 1.75 to 2.25 mm between surface 28 and 32. According to an exemplary embodiment, the ratio of the wall thickness between border section 20 and cover portion 21 is in the range of about 4:1 to 1.25:1. Border section 20 comprises a wall or side 34 that intersects surface 30 of cover 10 at an angle in the range of about 20 to 40 degrees. According to an exemplary embodiment, the width of border section 20 between the edge of tear seam 18 and side 34 is in the range of about 5 to 15 mm, preferably in the range of about 7 to 13 mm. According to an alternative embodiment, air bag cover 10 provides a tear seam without having a border section 20 of a greater thickness surrounding it (i.e., the area that surrounds the tear seam has approximately the same thickness as substantially the rest of the cover.)

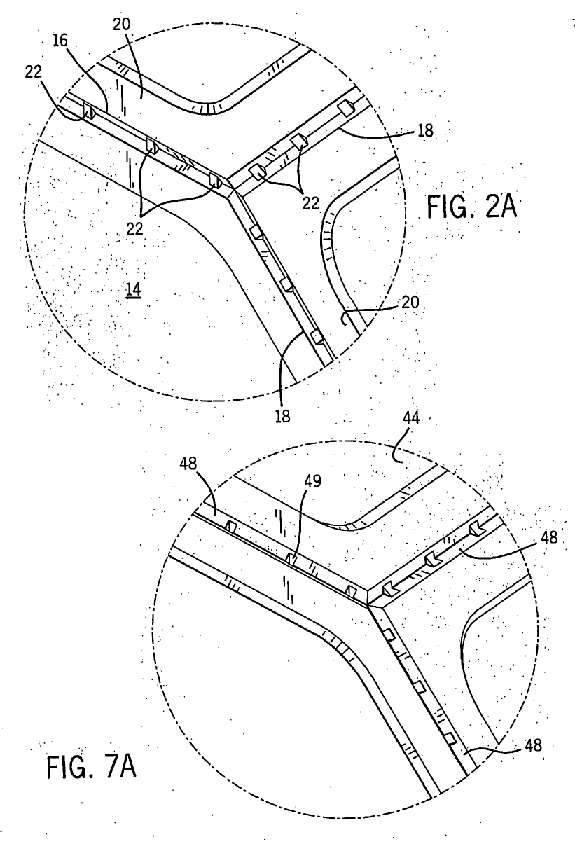

Referring to FIGS. 2 and 3, tear seam 16 and outer tear seams 18 comprise a plurality of members 22 (e.g., supports, bridges, ridges, projections, bumps, spanners, etc.) that extend between the wall surfaces of the groove defining the tear seams 16, 18. Members 22 are configured to extend across a width of tear seams 16, 18 to provide support against deformation (e.g., inward curving or bending of the tear seam walls) of tear seams 16, 18 after cover 10 is formed to prevent or inhibit the walls (which define the groove) from collapsing into the groove (i.e., stress risers). Members 22 are provided at intervals along the length of each tear seam 16, 18. As shown in the FIGURES, members 22 are spaced at substantially regular intervals along the seam path. As shown in the FIGURES, members 22 are preferably of a substantially uniform height along tear seams 16, 18 (e.g., measured from the lowest point in the tear seam) and a substantially uniform width along tear seams 16, 18 (e.g., measured between the sides of the tear seam). Alternatively, the members may be spaced at varying distances from each other or at varying depths (or heights) within the groove. Members 22 are also intended to obscure the visibility of tear seam 18 from A-side 12 by breaking up the appearance of the tear seam line along its length. According to an exemplary embodiment, outer tear seams 18 comprise ramps or inclines 24 that taper downward into outer tear seams 18. The incline 24 is intended to control the speed and direction of the separation or fracture at the end of the tear seam 18 by gradually increasing the amount of material that is being separated back to nominal (i.e., thickness of second portion 20). It is to be understood that the measurements of the components of the air bag cover may vary depending on the fracture characteristics desired for the air bag cover.

Referring to FIG. 4, tear seam 18 is shown as a triangular groove (e.g., depression, indenture, aperture, etc.). According to an exemplary embodiment, tear seam 18 comprises a generally triangular shape having two sides intersecting at an angle α. According to various exemplary embodiments, α may be any configuration to provide for a desired surface fracture. According to an alternative embodiment shown in FIG. 8, tear seams 16, 18 may have a radiused or semicircular groove 62. Alternatively, the tear seam may be formed by a square groove or any other suitable shape.

It is desirable to configure the air bag cover 10 so that the visibility of the tear seams 16, 18 is minimized to occupants of the vehicle. Greater uniformity along each tear seam diminishes irregularities and thereby helps minimize the visibility of the tear seams 16, 18. It is appreciated that variations or varying sizes and/or shapes of the tear seams can also result in minimal visibility of the tear seams. Accordingly, any of a variety of tear seam configurations are contemplated.

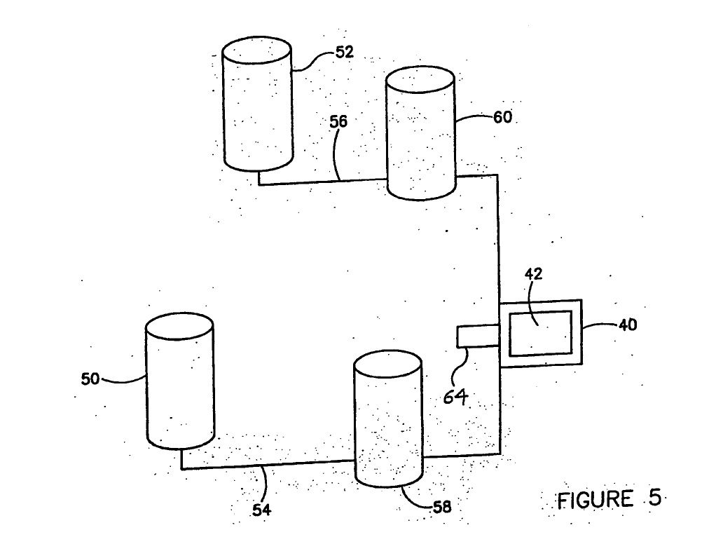

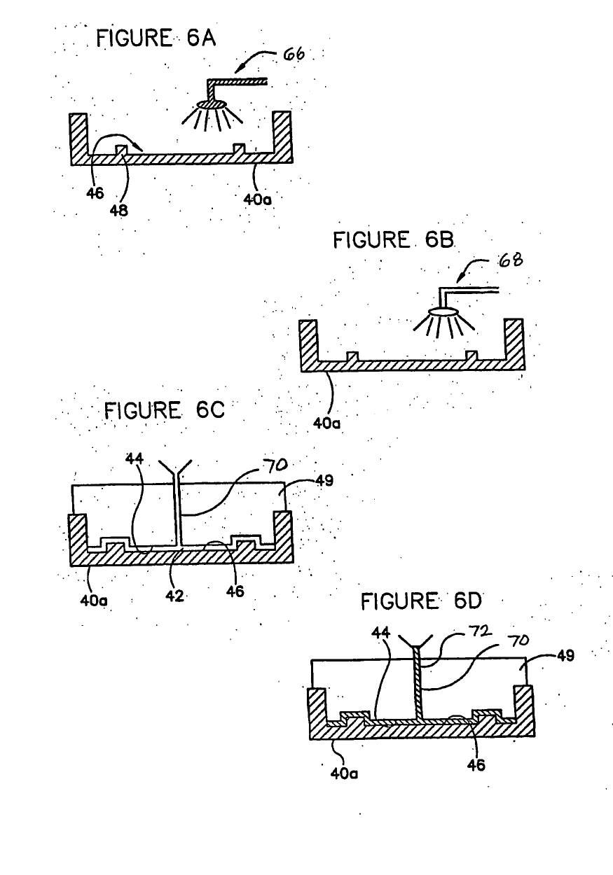

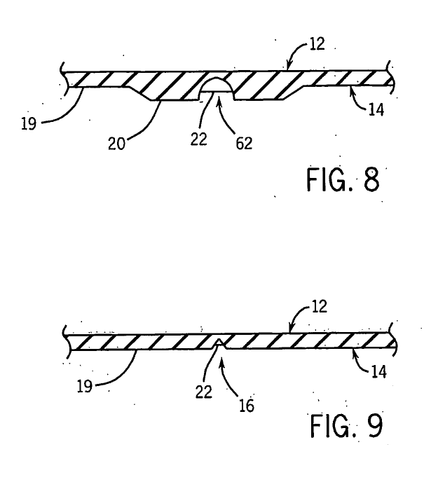

Referring to FIGS. 5 and 6A through 6D, a reaction injection molding (“RIM”) process for forming air bag cover 10 is shown according to an exemplary embodiment. It is preferred to use a RIM process for control of the wall thicknesses of the cover and border section. As shown in FIG. 6A, a mold 40 having a cavity 42 is provided to receive the injected components used to form air bag cover 10 (e.g., the skin). FIG. 6A provides an example of a highly simplified mold 40a that may be utilized to form A-side 12 and B-side 14 of the air bag cover and corresponding tear seams 16, 18 (as shown in FIG. 2). As illustrated, mold 40a comprises an interior or mold surface 46 (e.g., cavity side) which is configured to couple to a core surface 44 of core 49 in a sealing relation to define a cavity 42. According to an exemplary embodiment, core surface 44 comprises an (indented) profile 48 having the shape of tear seams 16, 18 and border section 20. Recesses 49 in profile 48 form members 22 in the tear seams. Core 49 (including core surface 44, profile 48, and recesses 49) defines the surface configuration and overall shape of B-side 14 of air bag cover 10 as the material injected into mold cavity 42 takes shape as defined by profile 48 and surface 44. For illustrative purposes, an exemplary embodiment of profile 48 of core surface 44 is shown in FIG. 7.

According to an exemplary embodiment, the RIM process uses polyurethanes to produce molded parts. The polyurethanes begin as two liquid components—isocyanate and polyol. The isocyanate material may be either an aromatic material (generally not light stable) or an aliphatic material (generally light stable). When using an aromatic material, it is preferred to apply a paint or other covering for protection from light. In exemplary embodiments, depending on how the polyurethane RIM system is formulated, the parts molded with it can be a foam or a solid, and they can vary from flexible to extremely rigid. The density can vary as well, with specific gravities ranging from about 0.2 to 1.8.

The polyurethane RIM process is a chemical reaction between the two liquid components, which are held in separate, temperature-controlled feed tanks 50, 52 as shown in FIG. 5. Referring to FIG. 5, the isocyanate and polyol are fed from these tanks 50, 52 through separate supply lines 54, 56 to a metering devices 58, 60 into a mixhead 64. According to an exemplary embodiment, when injection of the liquids into mold 40 begins, the valves of the mixhead 64 open. The liquid reactants enter a chamber in mixhead 64 at a predetermined pressure (e.g., lower than 3,000 psi) and are mixed by high-velocity impingement. From the mix chamber, the liquid flows into the mold 40 at approximately atmospheric pressure. Inside the mold 40, the liquid undergoes an exothermic chemical reaction which forms the polyurethane polymer in mold 40. According to various exemplary embodiments, cycle times vary depending on the part sizes and reaction conditions. In many cases, mold 40 may be injected with material and cured within about ninety seconds. Skin demolding then follows.

FIGS. 6A through 6D show how the mold is formed in the cavity in greater detail. Referring to FIG. 6A, a release spray 66 is applied in and/or to cavity 40a As shown in FIG. 6A, release spray 66 is applied to mold surface 46. Release spray 66 is intended to facilitate the removal of the air bag cover from the mold after demolding. Referring to FIG. 6B, a paint spray 68 is applied in and/or to cavity 40a. As shown in FIG. 6B, paint spray 68 may also be applied to mold surface 46. Paint spray 68 provides the appropriate color and appearance characteristics for the finished product (e.g., air bag cover) as well as light stability for aromatic based material (isocynate). Release spray 66 and/or paint spray 68 may be applied either manually or by a spray. apparatus. According to various alternative embodiments, the release spray and/or paint spray are not applied in and/or to the cavity. Referring to FIG. 6C, core 49 is positioned over mold 40a to form cavity 42 between mold surface 46 and core surface 44. An injection region or portion 70 is provided through core 49 to allow for the injection of material 72 into cavity 42. Referring to FIG. 6D, material 72 is injected into cavity 42 between core surface 44 of core 49 and mold surface 46 of mold 40a. According to an exemplary embodiment, injected material 72 is injected at an angle in the range of about 80 to 100 degrees relative to mold surface 46. According to a preferred embodiment, injected material 72 is injected at approximately a 90 degree angle with respect to cavity 40a. After being injected into cavity 42, injected material 72 is cured and demolded after a period of time that depends on a number of factors such as temperature, component material characteristics, etc. According to an exemplary embodiment, injected material 72 is cured and demolded at a temperature above 100 degrees F. According to various exemplary embodiments, the cavity surface (for forming the A-surface) and the core surface (for forming the B-surface) may comprise nickel shell (e.g., electroplated, nickel vapor deposition, etc.), steel (machined, etc.), aluminum (machines, cast, etc.), spray metal alloys, etc.

According to a preferred embodiment, the process for forming an air bag cover 10 comprises providing reaction injection molding materials into a mixhead 64 to form an injection material 72; introducing the injection material 72 into a mold 40 comprising a mold cavity 42 and a core 49 so that the air bag cover 10 is formed by a reaction between the reaction injection molding materials; forming a first portion 19 comprising a first wall thickness, an outer surface 28 configured to face an interior area of a vehicle, and an inner surface 32 opposite the outer surface 30, 32; forming a second portion 20 integral with the first portion 19 and having a second wall thickness greater than the first wall thickness and defining a tear seam 16, 18; forming a plurality of support members 22 within the tear seam that extend across a width of the tear seam; and demolding the injection material. The process may also include applying a paint spray 68 to the mold cavity 42 prior to introducing the injection material 72 and applying a release spray 66 to the mold cavity 42 prior to introducing the injection material 72. The process may also include utilizing the mold cavity 42 to form the outer surface 28.

Reaction injection molded polyurethane is the preferred method and material for making the air bag cover. According to an exemplary embodiment, cover 10 may be substantially flat in shape. According to alternative embodiments, the cover may comprise other geometric configurations such as a cup shape so that the perimeter is attachable to a base element on a steering module. Other shapes for the cover can vary depending on the particular geometry of the parts involved.

It is also important to note that the construction and arrangement of the elements of the air bag cover as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, elements shown as integrally formed may be constructed of multiple parts (e.g., multiple layers to create the air bag cover) or elements shown as multiple parts may be integrally formed, the operation of the interfaces may be reversed or otherwise varied, the length or width of the structures and/or other elements of the system may be varied. It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present invention as defined in the appended claims. The order or sequence of any process or method steps may be varied or re-sequenced according to alternative embodiments. In the claims, any functional description is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as described herein.

What is claimed is:

1. A molded air bag cover for use in a vehicle to cover an air bag, the air bag cover comprising:
a first portion providing a substantial portion of the air bag cover and having a first wall thickness; and
a second portion having a second wall thickness and defining a tear seam comprising a groove;
wherein the second wall thickness is greater than the first wall thickness;
wherein the air bag cover opens by surface fracture along the groove upon application of force by the air bag as the air bag is inflated to allow the air bag to pass through the air bag cover.

2. The air bag cover of claim 1 wherein the second wall thickness of the second portion of the air bag cover is configured to inhibit separation of the first portion and the second portion beyond the tear seam.

3. The air bag cover of claim 1 wherein the tear seam comprises at least one member that extends across a width of the tear seam.

4. The air bag cover of claim 3 wherein the at least one member is configured to inhibit deformation of the tear seam.

5. The air bag cover of claim 4 wherein the at least one member comprises a plurality of support members extending between walls of the groove and spaced along the tear seam.

6. The air bag cover of claim 5 wherein the support members are substantially the same distance from on another.

7. The air bag cover of claim 1 wherein the tear seam comprises a substantially uniform depth along a substantial length of the tear seam.

8. The air bag cover of claim 1 wherein the first portion and the second portion comprise a polyurethane material.

9. The air bag cover of claim 8 wherein the a polyurethane material is formed by reaction injection molding.

10. The air bag cover of claim 9 wherein the reaction injection molding comprises a reaction between at least isocyanate and polyol.

11. The air bag cover of claim 10 wherein the isocyanate is an aromatic material or an aliphatic material.

12. The air bag cover of claim 1 wherein the separation of the first portion beyond the tear seam comprises surface fracture of the air bag cover at a point on the air bag cover that is not on the tear seam.

13. The air bag cover of claim 1 wherein the tear seam comprises a plurality of secondary tear seams that intersect a primary tear seam.

14. The air bag cover of claim 1 wherein the tear seam is substantially not visible on the outer surface of the air bag cover.

15. A process for forming an air bag cover comprising:
providing reaction injection molding materials into a mixhead to form an injection material;
introducing the injection material into a mold comprising a cavity and a core so that the air bag cover is formed by a reaction between the reaction injection molding materials;
forming a first portion comprising a first wall thickness, an outer surface configured to face an interior area of a vehicle for occupants, and an inner surface opposite the outer surface;
forming a second portion integral with the first portion, the second portion having a second wall thickness greater than the first wall thickness and defining a tear seam; and
demolding the injection material.

16. The process of claim 15 further comprising providing the core with a profile comprised of a plurality of projections to form the inner surface and tear seam.

17. The process of claim 16 further comprising utilizing the cavity to form the outer surface.

18. The process of claim 17 further comprising applying a paint spray to the cavity prior to introducing the injection material and applying a release spray to the cavity prior to introducing the injection material.

19. The process of claim 15 further comprising forming a plurality of support members within the tear seam that extend across a width of the tear seam.

20. The process of claim 19 further comprising spacing each of the plurality of support members substantially the same distance apart from each other.

21. A molded air bag cover for use in a vehicle to cover an air bag, the air bag cover comprising:
a first portion having an inner surface and an outer surface opposite the inner surface, the inner surface having a tear seam defined by a groove having a length and a width;
a plurality of members extending across the width of the groove to provide structural support to the first portion and inhibit deformation of the first portion along the tear seam;
wherein the air bag cover opens by surface fracture along the groove upon application of force by the air bag as the air bag is inflated to allow the air bag to pass through the air bag cover.

22. The air bag cover of claim 21 wherein the at least one member comprises a plurality of support members extending between walls of the groove and spaced along the tear seam.

23. The air bag cover of claim 21 wherein the groove comprises a tapered region that increases the wall thickness of the groove at the end of the tear seam.

24. The air bag cover of claim 23 wherein the tapered region is configured to affect the speed and direction of the separation of the tear seam.

25. The air bag cover of claim 21 further comprising a second portion, wherein the wall thickness of the first portion is greater than the wall thickness of the second portion to inhibit separation of the first portion and the second portion beyond the tear seam.
